(19) United States
(12) Patent Application Publication
(10) Pub. No.: US 2015/0008773 A1
(43) Pub. Date: Jan. 8, 2015

(54) ALTERNATOR INCLUDING ELECTRICAL CONNECTOR ASSEMBLY

(71) Applicant: Remy Technologies, L.L.C., Pendleton, IN (US)

(72) Inventor: Attila Nagy, Fishers, IN (US)

(73) Assignee: Remy Technologies, L.L.C., Pendleton, IN (US)

(21) Appl. No.: 13/935,624

(22) Filed: Jul. 5, 2013

(51) Int. Cl. H02K 11/00; H02K 15/00

(52) U.S. Cl. CPC H02K 11/0094; H02K 15/00
USPC 310/71; 29/596

(57) ABSTRACT

An electrical machine includes a voltage regulator, a rectifier, a first terminal structure, and a second terminal structure. The voltage regulator includes a first electrical lead. The rectifier includes a second electrical lead. The first terminal structure extends from the first electrical lead and defines a receptacle opening. The first terminal structure includes (i) a first prong configured to at least partially occlude the receptacle opening, and (ii) a second prong configured to at least partially occlude the receptacle opening. The second terminal structure extends from the second electrical lead. The second terminal structure extends through the receptacle opening and defines a first connection surface against which the first prong is positioned, and an opposite second connection surface against which the second prong is positioned. The first terminal structure and the second terminal structure mechanically connect and electrically connect the first electrical lead to the second electrical lead.

### FIELD

The present disclosure relates to the field of alternators, and more particularly to alternators that include electrical connectors configured to make a mechanical and an electrical connection between two leads.

### BACKGROUND

Electrical connectors are typically used to connect a first lead to a second lead to enable the transfer of electrical energy therebetween. Some electrical connectors permanently connect the first lead to the second lead, whereas other types of electrical connectors establish a temporary electrical connection between the leads. Additionally, certain types of electrical connectors are used to establish a mechanical connection between the first lead and the second lead.

One application in which electrical connectors are used is with electrical machines, such as an alternator assembly of a vehicle. The typical alternator assembly includes a stator, a rotor, and an electronics package. The stator is connected to an alternator housing, which is connected to frame of the vehicle. The rotor is mounted for rotation relative to the stator and is coupled to a rotational output of an engine of the vehicle. The electronics package is electrically connected to the rotor, the stator, and to a battery of the vehicle. Engine operation results in rotation of the rotor. Rotation of the rotor causes the alternator assembly to generate electrical energy, which is regulated by the electronics package into a form that is suitable to charge the battery and to operate other electrical loads of the vehicle.

Alternator assemblies are typically subjected to vibrations, temperature variations, and other disturbances. Accordingly, it is desirable for the electrical connectors associated with an alternator assembly to form a robust mechanical joint and electrical connection that is resistant to vibrational disturbances. Additionally, it is desirable for the electrical connections to be simple and quick to establish so that the assembly time of the alternator assembly is reduced.

For at least the reasons set forth above, further developments in the area of electrical connectors for electrical machines are desirable.

### SUMMARY

According to one embodiment of the disclosure, an electrical machine includes a voltage regulator assembly, a rectifier assembly, a first terminal structure, and a second terminal structure. The voltage regulator assembly includes a first electrical lead. The rectifier assembly includes a second electrical lead. The first terminal structure extends from the first electrical lead and defines a receptacle opening. The first terminal structure includes (i) a first prong configured to at least partially occlude the receptacle opening, and (ii) a second prong configured to at least partially occlude the receptacle opening. The second terminal structure extends from the second electrical lead. The second terminal structure extends through the receptacle opening and defines (i) a first connection surface against which the first prong is positioned, and (ii) an opposite second connection surface against which the second prong is positioned. The first terminal structure and the second terminal structure mechanically connect and electrically connect the first electrical lead to the second electrical lead.

According to another embodiment of the disclosure, an alternator assembly includes a voltage regulator assembly, a rectifier assembly, a first terminal structure, and a second terminal structure. The voltage regulator assembly includes a first electrical lead. The rectifier assembly includes a second electrical lead. The first terminal structure extends from the first electrical lead. The first terminal structure defines a receptacle opening and includes a bent prong assembly extending away from the receptacle opening. The bent prong assembly defines a connection edge. The second terminal structure extends from the second electrical lead. The second terminal structure (i) extends through the receptacle opening, and (ii) defines connection surface against which the connection edge is positioned. When the connection edge abuts the connection surface, the first electrical lead and the second electrical lead are mechanically and electrically connected.

According to yet another embodiment of the present disclosure, a method of electrically and mechanically connecting a rectifier assembly and a voltage regulator assembly of an alternator assembly includes placing a first terminal structure of a voltage regulator in proximity of a second terminal structure of a rectifier assembly, and inserting a post provided on one of the first terminal structure and the second terminal structure through a receptacle opening defined by another of the first terminal structure and the second terminal structure, such that the post bends a first prong and a second prong of the another of the first terminal structure and the second terminal structure during the inserting.

### BRIEF DESCRIPTION OF THE DRAWINGS

FIG. 1 is a block diagram view of a vehicle having an engine and an alternator assembly, as described herein;

FIG. 2 shows a plan view of the alternator assembly of FIG. 1, including a voltage regulator and a rectifier assembly;

FIG. 3 shows a perspective view of an electrical lead of the voltage regulator connected to an electrical lead of the rectifier assembly of the alternator assembly of FIG. 1;

FIG. 4 shows a plan view of a connection between the electrical leads shown in FIG. 3;

FIG. 5 shows a perspective view the connection between the electrical leads shown in FIG. 3;

FIG. 6 shows a flowchart depicting an exemplary method of connecting the electrical leads of FIG. 3;

FIG. 7 shows a perspective view of the electrical lead of the voltage regulator disconnected from the electrical lead of the rectifier assembly of the alternator assembly of FIG. 1;

FIG. 8 shows a plan view of a terminal structure of the electrical lead of the voltage regulator of the alternator assembly of FIG. 1;

FIG. 9 shows a cross sectional view of a housing associated with the electrical lead of the voltage regulator and another housing associated with the electrical lead of the rectifier assembly of the alternator assembly of FIG. 1, the first housing is shown disconnected from the second housing; and

FIG. 10 shows a cross sectional view of the housings of FIG. 9 connected to each other.

### DETAILED DESCRIPTION

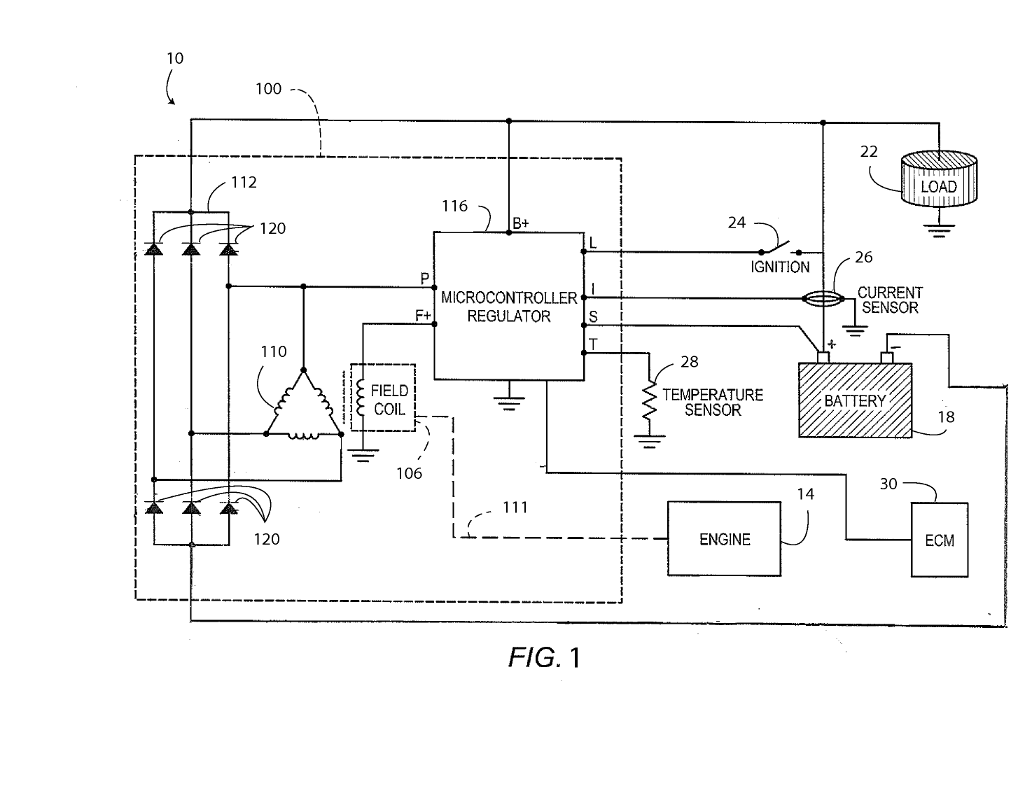

As shown in FIG. 1, a vehicle 10 includes an engine 14, a battery 18, and an electrical load 22 provided within a body (not shown) and supported by a vehicle chassis (not shown). The term “vehicle” as used herein refers to any device designed to carry or to transport something or someone, including, without limitation, cars, trucks, boats, trains, and planes.

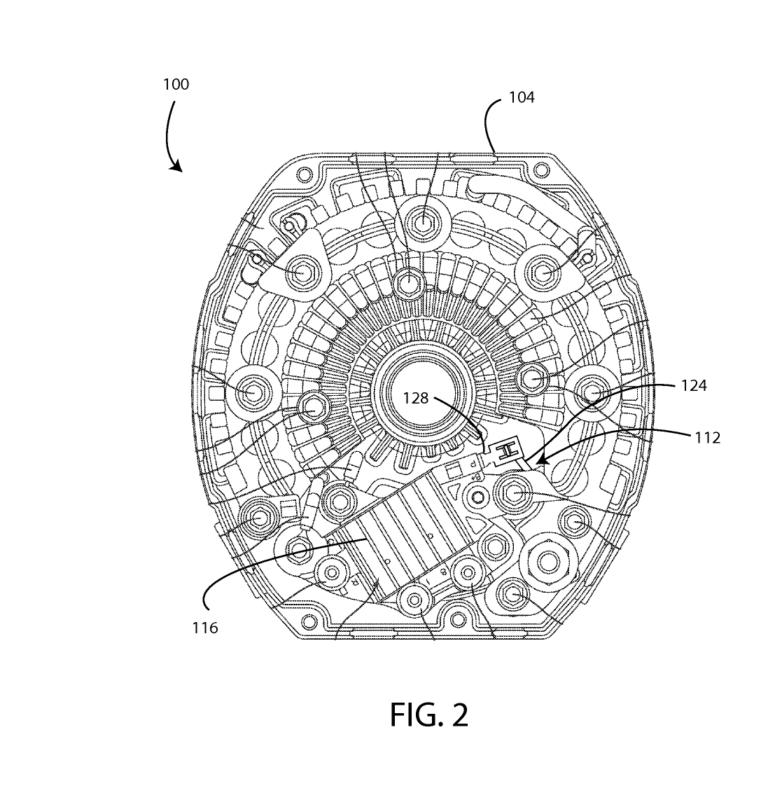

The vehicle 10 further includes an electrical machine shown as an alternator assembly 100. The alternator assembly 100 includes a metal frame/housing 104 (FIG. 2), a rotor 106 including a field coil mounted thereon, and a stator 110. The rotor 106 is positioned at least partially within the housing 104 and is configured for rotation relative to the housing and the stator 110. A coupling device 111, such as an endless belt, couples the rotor 106 to the rotational output of the engine 14.

The stator 110 is also positioned at least partially within the housing 104. The stator 110 is fixed in position with respect to the housing 104. The stator 110 is configured to output an alternating current signal in response to rotation of the rotor 106.

With reference to FIGS. 1 and 2, the alternator assembly 100 further includes a rectifier assembly 112 and a microcontroller voltage regulator referred to herein as a voltage regulator assembly 116. The rectifier assembly 112 includes a plurality of diodes 120 (FIG. 1) and an electrical lead 124 (FIG. 2) electrically connected to at least some of the diodes. The diodes 120 are electrically connected to the stator 110, the electrical load 22, the voltage regulator assembly 116, and the battery 14. The diodes 120 are configured to rectify the alternating current signal of the stator 110.

The voltage regulator assembly 116 is electrically connected to the field coil of the rotor 106, the stator 110, the electrical load 22, an ignition switch 24, a current sensor 26, the battery 18, a temperature sensor 28, and an electronic control module 30 of the vehicle 10. Additionally, an electrical lead 128 (FIG. 2) of the voltage regulator assembly 116 is electrically connected to the electrical lead 124 of the rectifier assembly 112 (identified by an arrow pointing to a connection between the rectifier assembly 112 and the voltage regulator assembly 116 in FIG. 2, shown schematically in FIG. 1). As known to those of ordinary skill in the art the voltage regulator assembly 116 regulates the electrical characteristics of the alternator assembly 100.

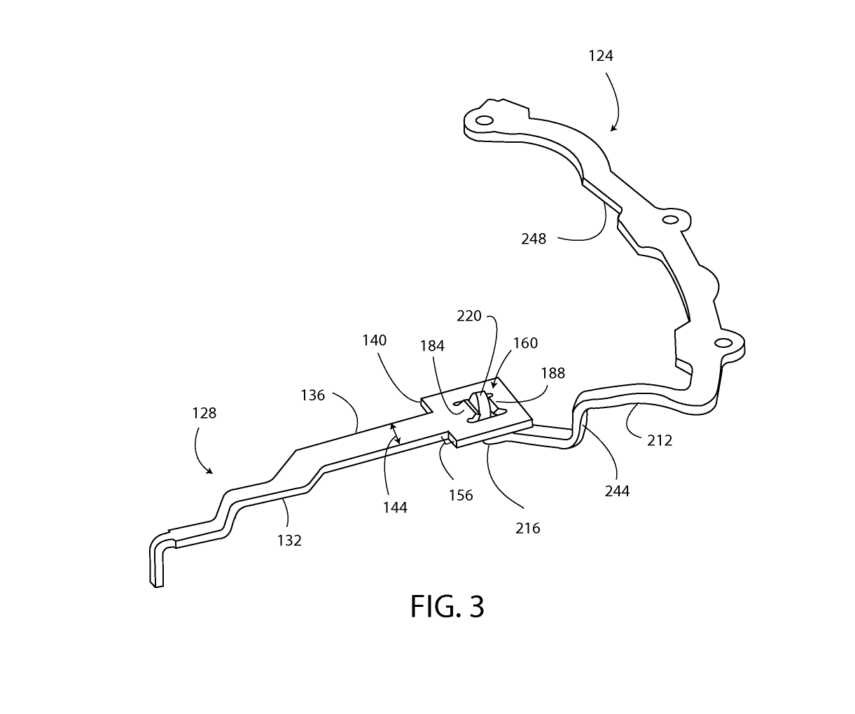

As shown in FIG. 3, an electrical and a mechanical connection is formed between the electrical lead 124 of the rectifier assembly 112 and the electrical lead 128 of the voltage regulator assembly 116. The electrical lead 128 of the voltage regulator 116 is formed from an electrically conductive and resilient material, such as copper, another type of metal, a metal alloy, or any other suitable material as desired by those of ordinary skill in the art.

The electrical lead 128 defines a connection portion 132, an elongated portion 136, and a female terminal structure 140. The connection portion 132 has a shape that is based on the shape of the housing 104 and/or routing of the connection portion around components connected to the housing. The elongated portion 136 extends from the connection portion 132 and is terminated with the female terminal structure 140. As illustrated, the elongated portion 136 is generally rectangular in shape and defines a width 144. In another embodiment, the elongated portion 136 has a shape that is based on the shape of the housing 104 and/or routing of the elongated portion around components connected to the housing.

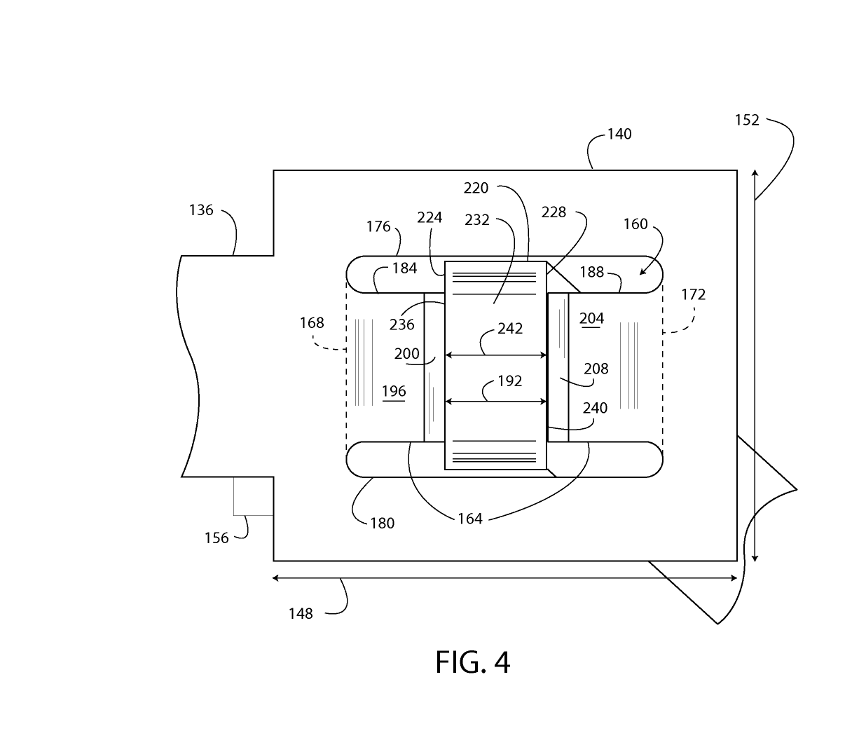

As shown in FIG. 4, the female terminal structure 140 extends from the elongated portion 136 of the electrical lead 128 and defines a generally rectangular periphery having a length 148 and a width 152. In the illustrated embodiment, the length 148 and the width 152 of the female terminal structure 140 are greater than the width 144 of the elongated portion 136. Also, an approximately right angle 156 is defined between the female terminal structure 140 and the elongated portion 136.

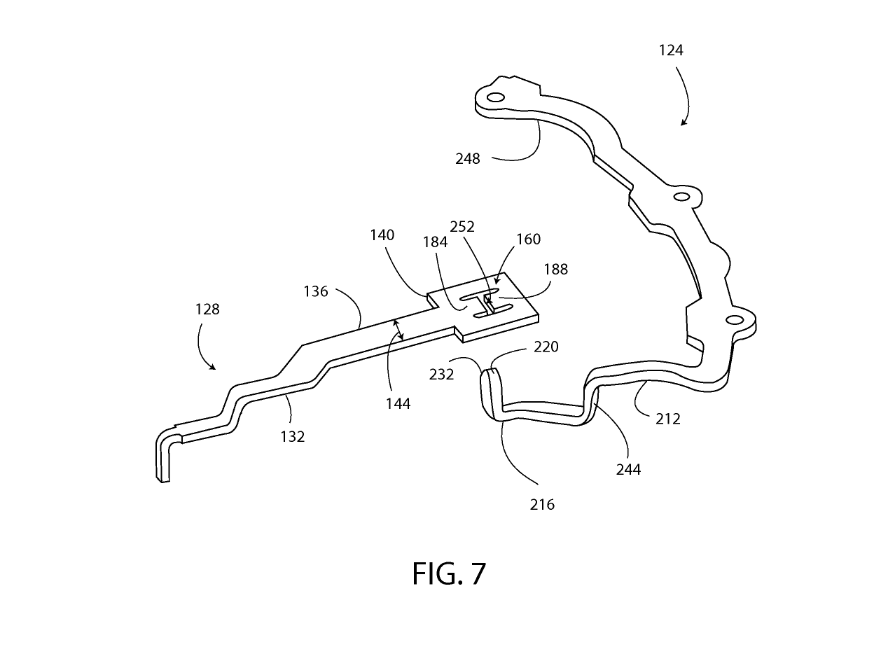

The female terminal structure 140 defines a receptacle opening 160 and includes a bent prong assembly 164 extending away from the receptacle opening. The receptacle opening 160 is at least partially defined by a left wall 168 (broken line), an opposite right wall 172 (broken line), an upper wall 176, and a lower wall 180. The receptacle opening 160 is rectangular, but the receptacle opening is partially occluded by the bent prong assembly 164, such that the receptacle opening has a shape that is similar to the shape of a capital letter “H” (see also FIG. 7).

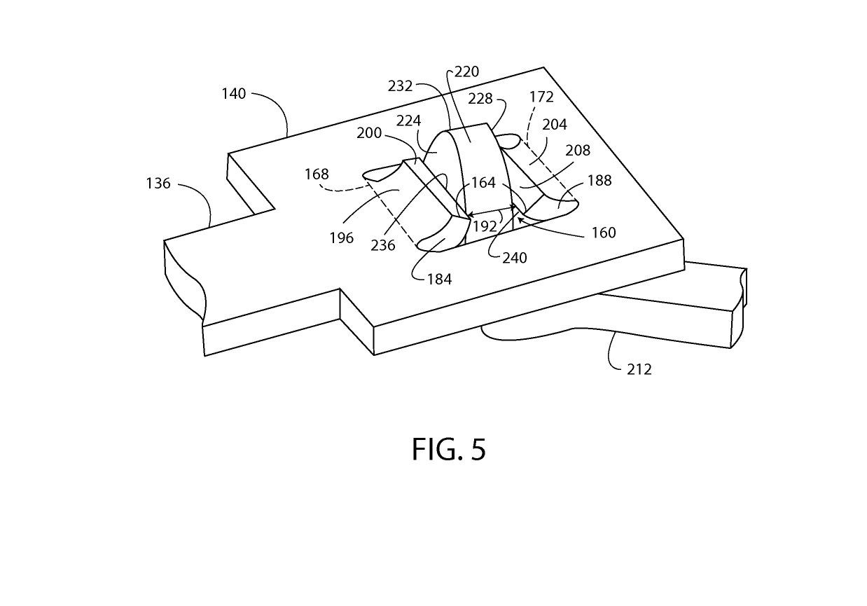

As shown in FIGS. 4 and 5, the bent prong assembly 164 includes a left prong 184 and a right prong 188 spaced apart by a bent gap distance 192. The left prong 184 is partially positioned within the receptacle opening 160 and is located to partially occlude the receptacle opening. Specifically, the left prong 184 extends from the left wall 168 towards the right wall 172 and extends away from the receptacle opening 160, such that the left prong defines a left curved surface 196. The curved surface 196 extends between the left wall 168 and a distal end portion 200 of the left prong 184. The curved surface 196 is curved away from the receptacle opening 160. The term “curved” as used herein includes surfaces that are angled, bent, and/or otherwise nonlinear.

The distal end portion 200 of the left prong 184 is generally rectangular and defines a connection edge 236. The connection edge 236 is a generally straight edge that extends across the left prong 184. The connection edge 236 is formed at the intersection of the distal end portion 200 and a bottom surface 214 of the left prong 184. In the illustrated embodiment, the distal end portion 200 intersects the bottom surface 214 at an approximately ninety degree angle to define the connection edge 236.

The right prong 188 is partially positioned within the receptacle opening 160 and is located to partially occlude the receptacle opening. Specifically, the right prong 188 extends from the right wall 172 towards the left wall 168 and extends away from the receptacle opening 160, such that the right prong defines a right curved surface 204. The curved surface 204 extends between the right wall 172 and a distal end portion 208 of the right prong 188. The curved surface 204 is curved away from the receptacle opening 160.

The distal end portion 208 of the right prong 188 is generally rectangular and defines a connection edge 240. The connection edge 240 is a generally straight edge that extends across the right prong 188. The connection edge 240 is formed at the intersection of the distal end portion 208 and a bottom surface 218 of the right prong 188. In the illustrated embodiment, the distal end portion 208 intersects the bottom surface 218 at an approximately ninety degree angle to define the connection edge 240.

With reference again to FIG. 3, the electrical lead 124 of the rectifier assembly 112 is formed from an electrically conductive material, such as copper, another type of metal, a metal alloy, or any other suitable material as desired by those of ordinary skill in the art. The electrical lead 124 defines a connection portion 212 from which a male terminal structure 216 extends. The male terminal structure 216 includes a post 220 that extends through the receptacle opening 160 and is positioned between the left prong 184 and the right prong 188.

As shown in FIGS. 4 and 5, the post 220 defines a left connection surface 224, an opposite right connection surface 228, and a distal end portion 232 positioned therebetween. The left connection surface 224 is positioned in contact with the left connection edge 236 of the left prong 184. Similarly, the right connection surface 228 is positioned in contact with the right connection edge 240 of the right prong 188. The left connection surface 224 is substantially parallel to the right connection surface 228, and the left connection surface is spaced apart from the right connection surface by a width 242 of the post 220. The distal end portion 232 has a rounded or a semi-circular profile (FIG. 5) that is configured to fit between the upper wall 176 and the lower wall 180 of the receptacle opening 160. The width 242 of the post 220 is substantially equal to the bent gap distance 192.

With reference again to FIG. 3, the connection portion 212 has a shape that is based on the shape of the housing 104 and/or routing of the connection portion around components connected to the housing. As illustrated, the connection portion 212 defines a step portion 244 and includes an arcuate portion 248. The arcuate portion 248, in at least one embodiment, is electrically connected to the diodes 120 of the rectifier assembly 112.

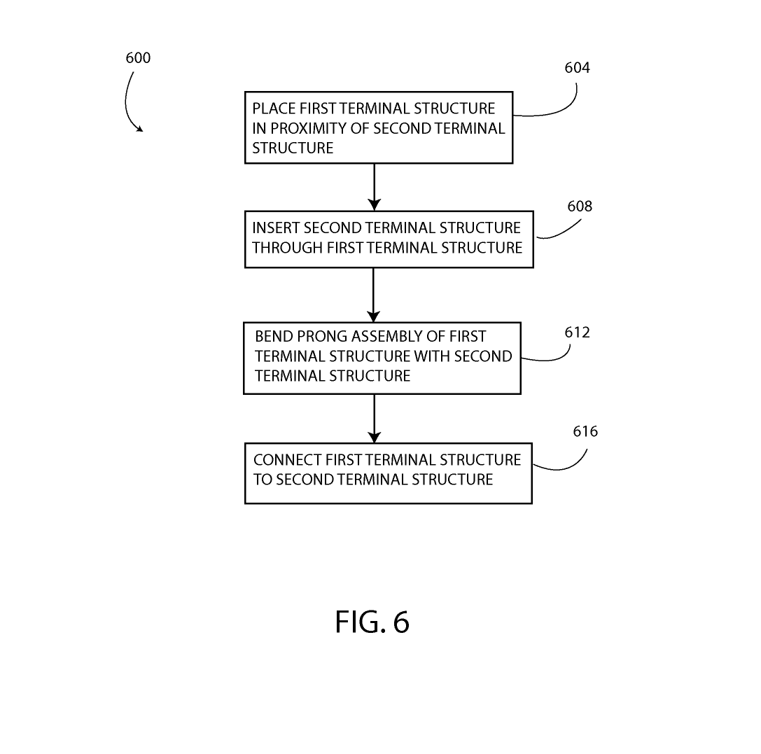

As shown in FIG. 6, a method 600 is presented for mechanically and electrically connecting the electrical lead 128 of the voltage regulator assembly 116 to the electrical lead 124 of the rectifier assembly 112 using the female terminal structure 140 and the male terminal structure 216. With reference to block 604 and to FIG. 7, first the male terminal structure 216 is placed in proximity of the female terminal structure 140. In particular, the post 220 is positioned below the space 252 between the left prong 184 and the right prong 188. The terminal structures 140, 216 in some embodiments are positioned in proximity to each other by hand, and in other embodiments are positioned in proximity to each other by machine.

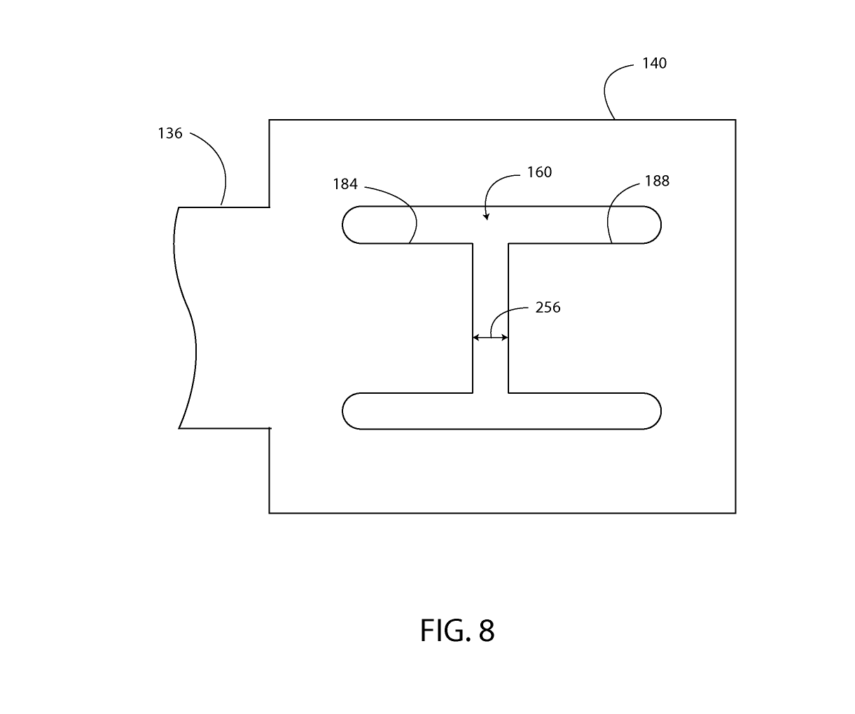

As illustrated in FIGS. 7 and 8, before the male terminal structure 216 is received by the female terminal structure 140, the bent prong assembly 164 is in an unbent position. In the unbent position, the male terminal structure 216 is spaced apart from the female terminal structure 140. Also, in the unbent position an unbent gap distance 256 (FIG. 8) is defined between the prongs 184, 188. The unbent gap distance 256 is less than the bent gap distance 192 (FIG. 4) and is less than the width 242 (thickness) of the post 220. Accordingly, in the configuration of FIG. 7, the post 220 is prevented from passing between the prongs 184, 188 without bending or otherwise deforming the female terminal structure 140.

Next, as shown in block 608, the post 220 is inserted through the receptacle opening 160 of the female terminal structure 140. During insertion, the post 220 is moved in an upward direction (as shown in FIG. 7). Initially, the post 220 contacts the unbent prongs 184, 188 and is prevented from passing through the receptacle opening 160, since the unbent gap distance 256 is narrower than the width 242 of the post 220.

With reference to block 612, continued movement of the post 220 in the upward direction forces the post to extend between the prongs 184, 188 as the post enters the receptacle opening 160 by bending the prongs. Since the post 220 is wider than the unbent gap distance 256, movement of the post deforms the female terminal structure 140 by bending the prongs 184, 188 away from the receptacle opening 160 until the prongs are separated enough to enable the post to move therebetween. The resiliency of the prongs 184, 188 keeps the prongs strongly biased against the connection surfaces 224, 228 of the post 220, thereby forming a mechanical joint between the terminal structures 140, 216. Specifically, the connection edges 236, 240 are strongly biased against the connection surfaces 224, 228 of the post 220.

With reference to block 616, when the post 220 has been inserted through the receptacle opening 160, the male terminal structure 216 is mechanically and electrically connected to the female terminal structure 140. In particular, moving the post 220 through the receptacle opening 160 between the prongs 184, 188 establishes a press-fit connection between the male terminal structure 216 and the female terminal structure 140. Furthermore, bending the prongs 184, 188 from the unbent position of FIG. 7 to the bent position of FIG. 3 forms the curved surfaces 196, 204, which extend toward the distal end portion 232 of the post 220. The post 220 is inserted through the receptacle opening 160 by hand or by machine; accordingly, connection of the female terminal structure 140 to the male terminal structure 216 is simple and quick to establish, thereby reducing the assembly time of the alternator assembly 100.

As shown in FIG. 5, when the post 220 is inserted through the receptacle opening 160, only the connection edges 236, 240 of the prongs 184, 188 abut the connection surfaces 224, 228 to electrically and mechanically connect the electrical lead 124 to the electrical lead 128. The rest of the prongs 184, 188 other than the connection edges 236, 240 are spaced apart from the post 220. The connection edges 236, 240 define a sharp edge that scrapes against the post 220 as the post is moved in the upward direction. The scraping of the post 220 removes any coating or varnish from the post so that a robust electrical connection is made between the post and the female terminal structure 140.

Furthermore, positioning the connection edges 236, 240 against the connection surfaces 224, 228 prevents movement of the post 220 in a downward direction (as shown in FIG. 3). This is because the configuration of the female terminal structure 140 tends to cause the connection edges 236, 240 to move toward the connection surfaces 224, 228 in response to movement of the post 220 in the downward direction, thereby resulting in the connection edges “digging into” the connection surfaces to further prevent movement of the post.

In some embodiments, solder is applied to the post 220 and to the prongs 184, 188. The solder at least partially fills the receptacle opening 160 and any spaces between the prongs 184, 188 and the post 220 to strongly mechanically and electrically connect male terminal structure 216 to the female terminal structure 140. Solder, however, is not required to form a strong mechanical and electrical connection between the male terminal structure 216 and the female terminal structure 140.

In another embodiment, the female terminal structure 140 extends from the electrical lead 124 of the rectifier assembly 112, and the male terminal structure 216 extends from the electrical lead 128 of the voltage regulator assembly 116.

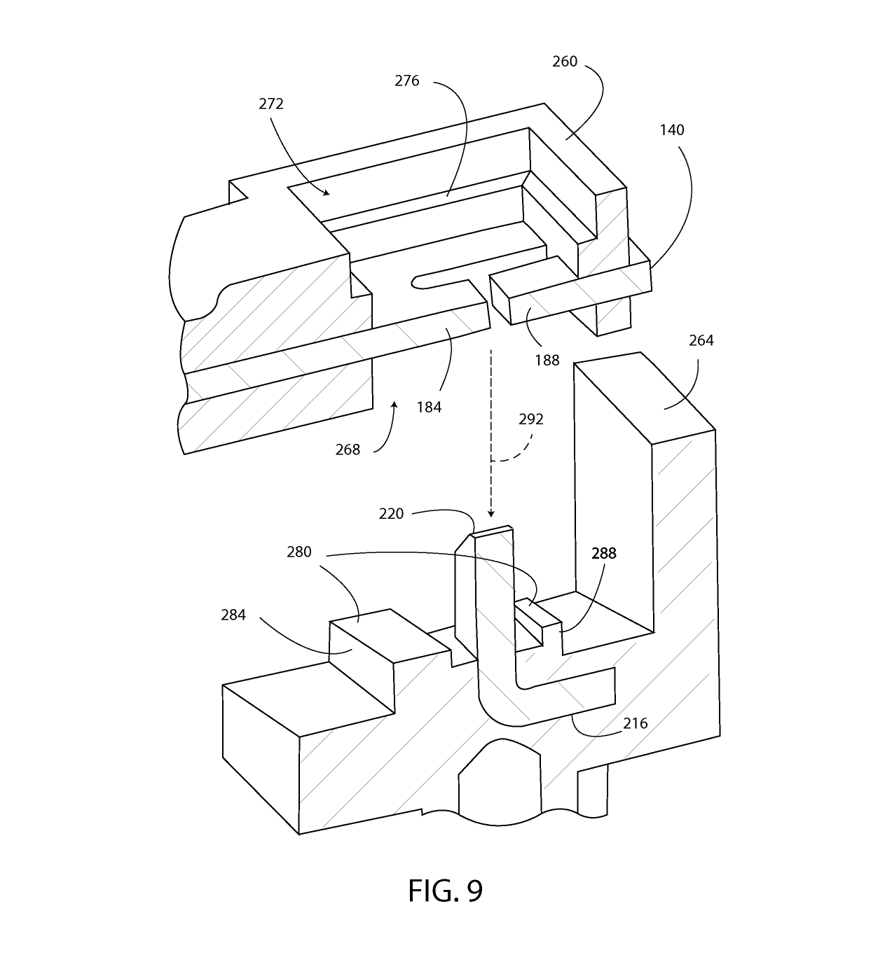

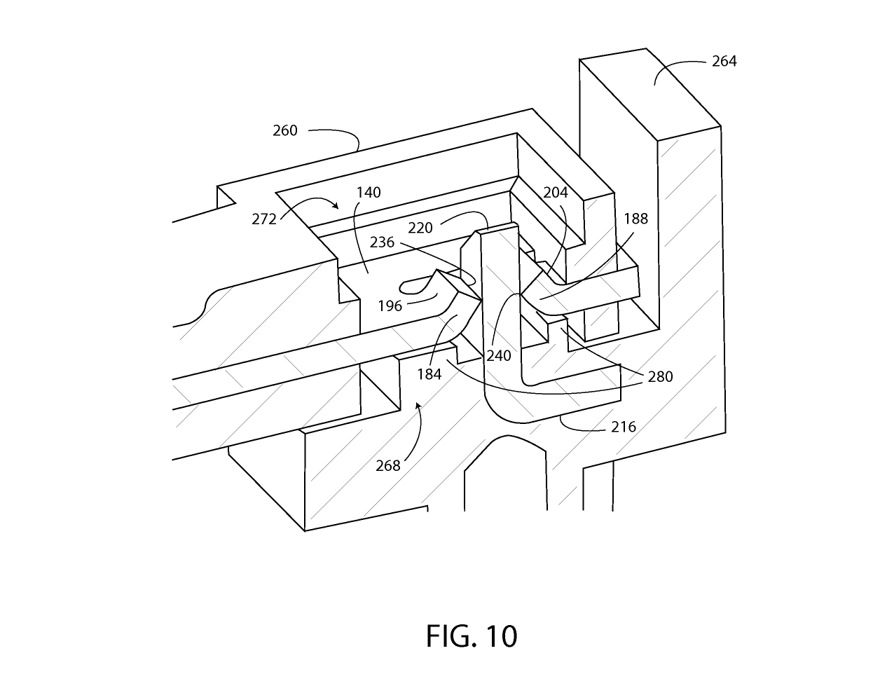

As shown in FIGS. 9 and 10, in at least one embodiment the female terminal structure 140 is received by an upper housing 260, and the male terminal structure 216 is received by a lower housing 264. The housings 260, 264 are formed from an electrically insulating material, such as glass-filled plastic or any other suitable material as desired by those of ordinary skill in the art.

The upper housing 260 defines a lower keyed recess 268 and an upper keyed recess 272. The lower keyed recess 268 is substantially rectangular and is partially defined by the female terminal structure 140. The upper keyed recess 272 includes a ledge portion 276 and is also substantially rectangular.

The lower housing 264 defines a keyed structure 280 that is configured to interlock with the lower keyed recess 268. The keyed structure 280 includes a left ridge 284 spaced apart from a right ridge 288. The post 220 of the male terminal structure 216 extends between the left ridge 284 and the right ridge 288.

The upper housing 260 is configured to receive at least a portion of the keyed structure 280 in the lower keyed recess 268 when the male terminal structure 216 is connected to the female terminal structure 140. The upper keyed recess 272 is usable to align a soldering tool (not shown) with the connected terminal structures 140, 216. Additionally, in at least one embodiment, the upper keyed recess 272 serves as a reservoir for the solder that further connects the male terminal structure 216 to the female terminal structure 140.

When the keyed structure 280 is aligned with the lower keyed recess 268 (as shown in FIG. 9) the post 220 is positioned to be inserted through the receptacle opening 260 by moving the housings 260, 264 toward each other along a path 292. Accordingly, the housings 260, 264 simplify the process of connecting the male terminal structure 216 to female terminal structure 140 by making it easier to align the post 220 with the receptacle opening 160. The press-fit connection between the post 220 and the female terminal structure 140 maintains the housings 260, 264 in the interlocked position shown in FIG. 10. Additionally, in FIG. 10 it is further shown that when the electrical lead 128 of the voltage regulator assembly 116 is connected to the electrical lead 124 of the rectifier assembly 112, the connection edges 236, 240 are positioned against the connection surfaces 224, 228 of the post 220.

While the invention has been described with reference to exemplary embodiments, it will be understood by those skilled in the art that other implementations and adaptations are possible. For example, various changes may be made and equivalent elements may be substituted for elements thereof without departing from the scope of the invention. In addition to the foregoing examples, many modifications may be made to adapt a particular situation or material to the teachings of the invention without departing from the essential scope thereof. Also, there are advantages to individual advancements described herein that may be obtained without incorporating other aspects described herein. Therefore, it is intended that the invention not be limited to the particular embodiment disclosed for carrying out this invention, but that the invention will include all embodiments falling within the scope of the appended claims.

What is claimed is:

1. An electrical machine comprising:
a voltage regulator assembly including a first electrical lead;
a rectifier assembly including a second electrical lead;
a first terminal structure extending from the first electrical lead, the first terminal structure defining a receptacle opening and the first terminal structure including (i) a first prong configured to at least partially occlude the receptacle opening, and (ii) a second prong configured to at least partially occlude the receptacle opening; and
a second terminal structure extending from the second electrical lead, the second terminal structure extending through the receptacle opening, and the second terminal structure defining (i) a first connection surface against which the first prong is positioned, and (ii) an opposite second connection surface against which the second prong is positioned,
wherein the first terminal structure and the second terminal structure mechanically connect and electrically connect the first electrical lead to the second electrical lead.

2. The electrical machine of claim 1, wherein:
the first prong defines a first curved surface,
the second prong defines a second curved surface, and
the first curved surface and the second curved surface are curved (i) away from the receptacle opening, and (ii) towards a distal end portion of the second terminal structure.

3. The electrical machine of claim 1, wherein:
the second terminal structure includes a post that defines (i) the first connection surface, (ii) the second connection surface, and (iii) a distal end portion of the second terminal structure,
the first prong extends away from the receptacle opening toward the distal end portion of the second terminal structure, and
the second prong extends away from the receptacle opening toward the distal end portion of the second terminal structure.

4. The electrical machine of claim 1, wherein:
the receptacle opening is at least partially defined by a first wall and an opposite second wall,
the first prong extends from the first wall towards the second wall,
the second prong extends from the second wall towards the first wall, and
the second terminal structure is positioned between the first prong and the second prong.

5. The electrical machine of claim 1, wherein:
the first electrical lead includes an elongated portion that is terminated with the first terminal structure,
the elongated portion defines a first width,
the first terminal structure defines a rectangular periphery having a length and a second width, and
the first width is less than the length and the second width.

6. The electrical machine of claim 1, wherein:
the first prong defines a first connection edge,
the second prong defines a second connection edge,
the first prong biases the first connection edge against the first connection surface of the second terminal structure, and
the second prong biases the second connection edge against the second connection surface of the second terminal structure.

7. The electrical machine of claim 1, further comprising:
a first housing configured to receive at least a portion of the first terminal structure,
a second housing configured to receive at least a portion of the second terminal structure, and
the first housing is configured to interlock with the second housing in response to the second terminal structure extending through the receptacle opening.

8. An alternator assembly comprising:
a voltage regulator assembly including a first electrical lead;
a rectifier assembly including a second electrical lead;
a first terminal structure extending from the first electrical lead, the first terminal structure defining a receptacle opening and including a bent prong assembly extending away from the receptacle opening, the bent prong assembly defining a connection edge; and
a second terminal structure extending from the second electrical lead, the second terminal structure (i) extending through the receptacle opening, and (ii) defining connection surface against which the connection edge is positioned,
wherein when the connection edge abuts the connection surface the first electrical lead and the second electrical lead are mechanically and electrically connected.

9. The alternator assembly of claim 8, wherein:
the bent prong assembly is moveable from an unbent position to a bent position,
in the unbent position (i) the second terminal structure is spaced apart from the first terminal structure, and (ii) the bent prong assembly defines a gap distance having a first magnitude that is less than a thickness of the second terminal structure, and
in the bent position (i) the second terminal structure extends through the receptacle opening, and (ii) the gap distance defines a second magnitude that is greater than the first magnitude.

10. The alternator assembly of claim 9, wherein:
the second terminal structure is moved through the receptacle opening in a first direction to move the bent prong assembly to the bent position, and
in response to being in the bent position, the bent prong assembly prevents movement of the second terminal structure in a second direction that is opposite to the first direction.

11. The alternator assembly of claim 9, wherein moving the second terminal structure through the receptacle opening establishes a press-fit connection between the second terminal structure and the first terminal structure.

12. The alternator assembly of claim 9, wherein:
the bent prong assembly includes a first prong and a second prong, and
the gap distance is defined between the first prong and the second prong.

13. The alternator assembly of claim 12, wherein:
the receptacle opening is partially defined by a first wall and an opposite second wall,
the first prong extends from the first wall towards the second wall, and
the second prong extends from the second wall towards the first wall.

14. The alternator assembly of claim 8, wherein the rectifier assembly and the voltage regulator assembly are included in an alternator assembly of a vehicle.

15. A method of electrically and mechanically connecting a rectifier assembly and a voltage regulator assembly of an alternator assembly comprising:
placing a first terminal structure of a voltage regulator in proximity of a second terminal structure of a rectifier assembly; and
inserting a post provided on one of the first terminal structure and the second terminal structure through a receptacle opening defined by another of the first terminal structure and the second terminal structure, such that the post bends a first prong and a second prong of the another of the first terminal structure and the second terminal structure during the inserting.

16. The method of claim 15, wherein during the inserting the first prong is positioned against a first connection surface of the post and the second prong is positioned against a second connection surface of the post to electrically and to mechanically connect the first terminal structure to the second terminal structure.

17. The method of claim 16, wherein the post is inserted in a first direction, and the method further comprises:
preventing movement of the post in a second direction that is opposite to the first direction in response to (i) the first prong being positioned against the first connection surface, and (ii) the second prong being positioned against the second connection surface.

18. The method of claim 17, wherein the movement of the post in the second direction tends to move (i) the first prong toward the first connection surface, and (ii) the second prong toward the second connection surface.

19. The method of claim 15, wherein:
the bending the first prong causes the first prong to define a first curved surface,
the bending the second prong causes the second prong to define a second curved surface, and
the first curved surface and the second curved surface are curved (i) away from the receptacle opening, and (ii) towards a distal end portion of the post.

20. The method of claim 15, further comprising:
soldering the post to the first prong and the second prong
